(19) United States
(12) Patent Application Publication
(10) Pub. No.: US 2010/0308260 A1
(43) Pub. Date: Dec. 9, 2010

(54) LIQUID BLEACHING AGENT COMPOSITION

(76) Inventors: Masataka Maki, Wakayama (JP); Yuichiro Tase, Wakayama (JP); Hitoshi Ishizuka, Wakayama (JP); Nobuyoshi Yamaguchi, Wakayama (JP)

Correspondence Address: BIRCH STEWART KOLASCH & BIRCH, PO BOX 747, FALLS CHURCH, VA, 22040-0747, US

(21) Appl. No.: 12/864,627

(22) PCT Filed: Feb. 5, 2009
(86) PCT No.: PCT/JP2009/052344

§ 371 Date: Jul. 26, 2010

(30) Foreign Application Priority Data
Feb. 8, 2008 (JP) 2008-028483

(51) Int. Cl. C11D 3/395

(52) U.S. Cl. 252/186.41

(57) ABSTRACT

The present invention relates to a liquid bleaching agent composition containing (a) hydrogen peroxide, (b1) a nonionic surfactant, (b2) an anionic surfactant, (c) a bleaching activator, (d) at least one compound selected from boric acid, borax and a borate, and (e) a compound having one or more groups in which a hydroxyl group is present on each of the adjacent carbon atoms to each other, wherein the respective contents of component (b1), component (b2) and the mass ratio of component (b2) to component (b1) are all within a specific range and the composition has pH 2.5-4.5 at 20° C.

### FIELD OF THE INVENTION

The present invention relates to a liquid bleaching agent composition and a method of washing using the same.

### BACKGROUND OF THE INVENTION

A liquid oxygen type bleaching agent which includes hydrogen peroxide as a main component is an important bleaching agent for clothes as exhibiting little damage to dyes and fibers and also having convenience for direct application to dirt. However, compared to a chlorine type bleaching agent, it is inferior in bleaching effect and thus improvement of bleaching power remains as a big problem to be solved. Recently, for the purpose of increasing the bleaching power of the oxygen type bleaching agent, studies are being made regarding an organic peracid, which has a higher oxidizing power than hydrogen peroxide. As one example, a product containing an organic peracid precursor type (i.e., a bleaching activator) has been utilized in the field of clothes, etc. This bleaching activator reacts with hydrogen peroxide in a weakly alkaline washing bath to form an organic peracid, and therefore exhibiting an excellent bleaching effect.

Meanwhile, the stability of hydrogen peroxide is reduced in a weakly alkaline condition. As such, blending hydrogen peroxide in a typical liquid detergent composition which is neutral to weakly alkaline is difficult to achieve in view of storage stability of the composition. Thus, in order to maintain the storage stability of hydrogen peroxide, it is necessary to have the pH of a product in an acidic range. Further, since most of the bleaching activator that is used in combination with a bleaching agent including hydrogen peroxide has an active ester group, it can be easily hydrolyzed or degraded by addition of hydrogen peroxide and lose its activity in a weakly alkaline composition. For such reason, in actual case of washing, the effect of a bleaching activator is significantly reduced. Thus, even for maintaining the storage stability of a bleaching activator, it is necessary to have the pH of a product in an acidic range. A stable blend of a bleaching component is obtained in an acidic condition. It, however, is necessary to be accompanied by a detergent in a neutral to alkaline condition to obtain a bleaching effect. There is a problem that the bleaching effect is not obtained when used alone.

According to JP-A7-53994, JP-A7-70593, JP-A2006-169515 and JP-A2006-169517, a detergent composition based on a pH jump technique by which pH of a solution can be changed from acidic to weakly alkaline upon dilution is disclosed. Among these, especially in JP-A2006-169515 and JP-A2006-169517, a technique for achieving both the bleaching effect and the stability of a bleaching activator and hydrogen peroxide is disclosed.

According to JP-A2006-169515 and JP-A2006-169517, for general household washing, the detergent composition is diluted about 1,000 times by volume. It is also disclosed that in order to efficiently produce an organic peracid from a bleaching activator in a washing liquid, a pH of the composition after it is diluted 1,000 times by volume, has to be 8.5 or more. Thus, it is necessary to have the pH of the composition greater than 4.5.

Further, to achieve an improvement in the stability of a bleaching activator, it has been obvious from the studies of the inventors of the present invention that blending with a nonionic surfactant is effective. According to JP-A2006-169515 and JP-A2006-169517, a liquid detergent composition including a nonionic surfactant as a main base material is also disclosed.

In WO-A2007/077953, a liquid detergent composition including (a) hydrogen peroxide, (b) a bleaching activator, (c) a nonionic surfactant, (d) water, (e) boric acid, borax or a borate, and (f) a polyol compound, wherein the liquid detergent composition has a pH value of 4 to 7 at 20° C. is disclosed.

### SUMMARY OF THE INVENTION

The present invention is a liquid bleaching agent composition containing component (a), component (b1), component (b2), component (c), component (d) and component (e), wherein the content of component (b1) is 25-60 mass %, the content of component (b2) is 1.5-20 mass %, the mass ratio of component (b2) to component (b1) is 0.05-0.5 and the composition has pH 2.5-4.5 at 20° C.;

component (a): hydrogen peroxide

component (b1): a nonionic surfactant

component (b2): an anionic surfactant

component (c): a bleaching activator

component (d): at least one compound selected from boric acid, borax and a borate, and,

component (e): a compound having one or more groups in which a hydroxyl group is present on each of the adjacent carbon atoms to each other.

Herein below, component (b1) and component (b2) can be together referred to as component (b).

The present invention is a process for producing the above shown liquid bleaching composition, including mixing the components by a method including the following Step A, Step B, and Step C;

Step A (a concentrated premix of component (d)):

Preparing an aqueous solution of a boron compound in which the concentration of component (d) is 5-30 mass % and the concentration of water is 10-40 mass % in a premix by mixing component (d), component (e) and water;

Step B (concentrated premix of component (c)): Mixing water and/or component (b1) and/or component (b2) with component (c);

Step C (principal blending process):

Mixing the aqueous solution of a boron compound obtained by Step A, the bleaching activator solution obtained by Step B, and component (a) and, if necessary, other components.

The present invention is a process for producing the above shown liquid detergent composition, including mixing a solution obtained by the above shown Step A, before mixing at least one of component (a), component (b1), component (b2) and component (c).

The present invention is a process for producing the above shown liquid detergent composition, including, after initiating mixing of the solution obtained by the above shown Step A with other detergent components, mixing component (b1) and/or component (b2) to obtain a mixture adjust ed to pH 2.5-7, and subsequently mixing component (a) and the solution obtained by the above shown Step B with the mixture.

### DETAILED DESCRIPTION OF THE INVENTION

With respect to the pH range described in JP-A2006-169515 and JP-A2006-169517, it is found that under more severe storage conditions the storage stability of a bleaching activator and hydrogen peroxide is not entirely satisfactory. As a result, there is a problem that, compared to a fresh preparation just after preparation, a bleaching activity is significantly reduced after a long period of storage.

Storage stability can be improved if a nonionic surfactant is used in a large amount. However, in this case, reactivity of a bleaching activator is very much suppressed and production of an organic peracid after the dilution is impaired. In particular, if a pH after the dilution is less than 8.5, the production speed of producing an organic peracid is so slow that an effect of improving a bleaching activity cannot be obtained.

Thus, although a bleaching agent or a detergent based on a pH jump technique has been already known, a liquid bleaching agent composition which exhibits an excellent bleaching effect and also has excellent storage stability under severe conditions is now strongly required.

Under the circumstances, the present invention provides a liquid bleaching agent composition which has an excellent storage stability under severe conditions in the liquid bleaching agent composition based on pH jump system and can efficiently produce an organic peracid in the range of under pH 8.5, and therefore continuously provides an excellent bleaching effect.

The present invention provides a liquid bleaching agent composition which has excellent storage stability under severe conditions, can efficiently produce an organic peracid even when the dilution pH is not less than 8.5, and therefore can continuously provide an excellent bleaching effect. More specifically, it is preferable to be used for fiber materials such as clothes and the like.

According to the present invention, a nonionic surfactant and an anionic surfactant are blended in a specific amount/ratio, thus even when the washing pH after the dilution with water is less than 8.5, an organic peracid can be efficiently produced from a bleaching activator. As a result, a liquid bleach agent composition having low pH is provided. The composition of the present invention exhibits an excellent bleaching effect even after a long period of storage.

### Component (a)

The liquid bleaching agent composition of the present invention contains, as component (a), hydrogen peroxide. The content of component (a) is, in terms of hydrogen peroxide, preferably 0.1 to 30 mass %, more preferably 0.5 to 20 mass %, even more preferably 1 to 15 mass %, even more preferably from 1 to 10 mass %, based on the liquid bleaching agent composition. Within the range, an excellent bleaching effect and good stability can be obtained.

### Component (b)

The liquid bleaching agent composition of the present invention contains, as a surfactant of component (b), nonionic surfactant (b1) (herein below, referred to as “component (b1)”) and anionic surfactant (b2) (herein below, referred to as “component (b2)”).

Inventors of the present invention intensively studied to obtain the best way of bleaching using an organic peracid, and found that the bleaching property can be significantly enhanced in a limited pH region of 7 to 8.5 of a treatment liquid. Conventionally, it has been known that higher pH is more preferred in terms of production of a peracid. However, the inventors of the present invention found that, when the production amount of peracid is maintained constant, the performance can be dramatically enhanced in the pH region of 7 to 8.5. Although an exact mechanism remains unclear, it is expected that such result is based on the dissociation state of an organic peracid or an adsorption property to fibers or dirt, etc. According to the present invention, such an effect can be obtained with single agent type composition. Thus, in terms of cost for producing containers and convenience of use, the composition of the present invention is clearly advantageous.

Further, the inventors also found that, as a result of experiments to improve the production amount of an organic peracid by using various additives in pH range of 7 to 8.5, in which such excellent bleaching effect is obtained, the production of an organic peracid is significantly promoted by the presence of component (b2). Further, by further using component (b1) which can contribute to the stability of a bleaching activator and having the mass ratio between component (b1) and component (b2) within a specific range, the inventors succeeded in obtaining both the stability and the activity of the bleaching activator at the same time.

The nonionic surfactant as component (b1) is preferably a polyoxyalkylenealkyl ether type nonionic surfactant which contains an oxyethylene group (ethyleneoxy group) and/or an oxypropylene group (propyleneoxy group). Specifically, the compound having the following formula (1) can be mentioned.

R¹—O[(EO)ₐ/(PO)_{b}]—H (1)

(wherein R¹ is an alkyl group or alkenyl group having 10 to 18 carbon atoms, preferably 12 to 14 carbon atoms. EO and PO represent an ethyleneoxy group and a propyleneoxy group, respectively. a is the average mole number of units added, which is a number of from 0 to 20 and b is the average mole number of units added, which is a number of from 0 to 20, provided that a and b are not simultaneously 0. Preferably, the average mole number of units added, a, is from 6 to 15, more preferably from 7 to 12, and the average mole number of units added, b, is a number of from 0 to 10, more preferably from 1 to 5, even more preferably from 1 to 3, in terms of a washing property at the time of application. Meanwhile, the average mole number of units added, a, is preferably from 12 to 20, more preferably from 15 to 20, and the average mole number of units added, b, is a number of from 0 to 10, more preferably from 1 to 5, even more preferably from 1 to 3, in terms of the stability of a bleaching agent as component (c).

In formula (1), EO and PO may be arranged in the form of either a random copolymer or a block copolymer.

The polyoxyalkylene alkyl ether type nonionic surfactant may be arranged in the form of either a random copolymer or a block copolymer including an oxyethylene group (ethyleneoxy group) and an oxypropylene group (propyleneoxy group). Among these, in terms of the washing property and the stability of a bleaching activator as component (c), it is preferably a block copolymer. The block copolymer is even more preferably a compound represented by the following formula (2):

R²—O(EO)ₐ(PO)_{b}(EO)_{c}—H (2)

(wherein R² is an alkyl group or alkenyl group having 10 to 18 carbon atoms, preferably 12 to 14 carbon atoms. EO and PO represent an ethyleneoxy group and a propyleneoxy group, respectively. a is the average mole number of units added, which is a number of from 1 to 20, b is the average mole number of units added, which is a number of from 1 to 20, and c is the average mole number of units added, which is a number of from 1 to 20. Preferably, the average mole number of units added, a, is from 6 to 15, more preferably from 7 to 12, the average mole number of units added, b, is a number of from 1 to 10, more preferably from 1 to 5, even more preferably from 1 to 3, and the average mole number of units added, c, is from 6 to 15, more preferably from 7 to 12].

The content of component (b1) in the liquid bleaching agent composition of the present invention is preferably 25 to 60 mass %, more preferably 30 to 55 mass %, and even more preferably 35 to 50 mass %, in terms of a washing power and stability of a bleaching activator.

As to an anionic surfactant as component (b2), examples include alkyl (or alkenyl) benzene sulfonic acid salt which contains an alkyl group or an alkenyl group having 10 to 18 carbon atoms, polyoxyalkylenealkyl (or alkenyl)ether sulfonic acid ester salt which contains an alkyl group or an alkenyl group having 10 to 18 carbon atoms, alkyl (or alkenyl) sulfuric acid ester salt which contains an alkyl group or an alkenyl group having 10 to 18 carbon atoms, α-olefin sulfonic acid salt (having 10 to 18 carbon atoms), α-sulfofatty acid salt (having 10 to 18 carbon atoms), lower alkyl (having 1 to 5 carbon atoms) ester salt of α-sulfofatty acid (having 10 to 18 carbon atoms), or alkyl or alkenyl sulfonic acid salt (having 10 to 18 carbon atoms).

According to the present invention, polyoxyethylenealkyl sulfonic acid ester salt which contains an alkyl group having 10 to 14 carbon atoms and ethylene oxide with an average added mole number of 1 to 3, alkylbenzene sulfonic acid salt which contains an alkyl group having 11 to 15 carbon atoms, or alkyl or alkenylsulfonic acid salt (having 10 to 18 carbon atoms) are preferred in terms of an effect of promoting the production of an organic peracid. More preferred is alkylbenzene sulfonic acid salt which contains an alkyl group having 11 to 15 carbon atoms.

The content of component (b2) in the liquid bleaching agent composition of the present invention is preferably 1.5 to 20 mass %, more preferably 3 to 15 mass %, and even more preferably 5 to 10 mass %, in terms of a bleaching property and stability of a bleaching activator.

The content of component (b) in the liquid bleaching agent composition of the present invention, i.e., the sum of component (b1) and component (b2), is preferably 26.5 to 70 mass %, more preferably 30 to 60 mass %, even more preferably 35 to 55 mass %, and still even more preferably 35 to 50 mass %, in terms of a washing power and a bleaching power.

The mass ratio of component (b2)/component (b1) in the liquid bleaching agent composition of the present invention is 0.05 to 0.5. Further, in terms of obtaining an improvement in the storage stability of a bleaching activator in the storage and promoting the production of an organic peracid upon dilution with water, it is preferably 0.07 to 0.4. More preferably, it is 0.1 to 0.3.

It is considered that the bleaching activator, which is blended in a bleaching agent or a detergent that is produced based on a pH jump technique, can effectively produce an organic peracid with adjustment of pH to 8.5 or more when diluted water to exhibit a bleaching activity. However, the inventors of the present invention found that, by using both component (b1) and component (b2) in a specific content and a specific mass ratio, a sufficient amount of an organic peracid can be produced even when pH at the time of dilution with water is less than 8.5, and as a result an excellent bleaching effect can be obtained.

According to a conventional bleaching agent or a composition that is produced based on a pH jump technique, it has been considered necessary to adjust the pH of an undiluted liquid to 4.6 or more in order to have pH of about 8.5 or more after dilution. However, when an undiluted liquid is stored under the pH of 4.6 or more, there is a problem that the stability of the bleaching activator is significantly reduced under more severe storage conditions.

According to the liquid bleaching agent composition of the present invention, an excellent bleaching power by an organic peracid can be obtained even at pH of less than 8.5 after dilution, and therefore it is possible to have pH of an undiluted liquid to be in the range of 2.5 to 4.5. In addition, under more severe storage conditions, the stability of the bleaching activator can be significantly improved. As a result, obtaining an excellent bleaching effect over a long period of time becomes possible.

### Component (c)

The liquid bleaching agent composition of the present invention contains a bleaching activator as component (c). As to a bleaching activator as component (c), at least one selected from alkanoyloxybenzene sulfonic acid which contains an alkanoyl group having 8 to 14 carbon atoms, alkanoyloxybenzene carboxylic acid salt which contains an alkanoyl group having 8 to 14 carbon atoms, and salts thereof can be obtained. In terms of having both the production of a peracid upon dilution and the stability in a product, a bleaching activator that is selected from alkanoyloxybenzene sulfonic acid which contains a straight or branched alkanoyl group having 8 to 12 carbon atoms, alkanoyloxybenzene carboxylic acid which contains a straight or branched alkanoyl group having 8 to 12 carbon atoms, and salts thereof are preferred.

With respect to the bleaching activator of the present invention, when pH of an undiluted liquid is 2.5 to 4.0, a sulfonic acid type bleaching activator is preferred in terms of production of a peracid upon dilution. Nonanoyloxybenzene sulfonic acid and salts thereof are more preferred. When pH of an undiluted liquid is more than 4.0 but the same or less than 4.5, a carboxylic acid type bleaching activator is preferred in terms of the stability of the bleaching activator in a product. Further, alkanoyloxybenzene carboxylic acid which contains an alkanoyl group having 8 to 10 carbon atoms and salts thereof are more preferred, in terms of solution stability.

As to the salts, sodium salt, potassium salt, and magnesium salt are preferred. In terms of solubility, sodium salt is more preferred.

Specific examples of component (c) include the compounds that are selected from the following (c-1) to (c-6). The compounds that are selected from (c-2), (c-3), (c-5) and (c-6) are more preferred.

(c-1): Compound that is represented by the following formula (Isononanoyloxy-p-benzene carboxylic acid (3,5,5-trimethylhexanoyloxy-p-benzene carboxylic acid))

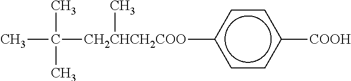

(c-2): Compound that is represented by the following formula (decanoyloxy-p-benzene carboxylic acid)

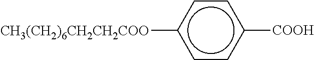

(c-3): Compound that is represented by the following formula (sodium decanoyloxy-p-benzene sulfonate)

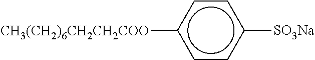

(c-4): Compound that is represented by the following formula (nonanoyloxy-p-benzene carboxylic acid)

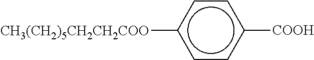

(c-5): Compound that is represented by the following formula (sodium nonanoyloxy-p-benzene sulfonate)

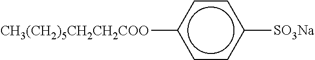

(c-6): Compound that is represented by the following formula (octanoyloxy-p-benzene carboxylic acid)

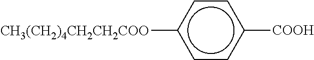

Further, when a bleaching activator which is selected from alkanoyloxybenzene sulfonic acid which contains an alkanoyl group having 8 to 14 carbon atoms and salts thereof is used, the mass ratio of component (b2)/component (b1) is preferably 0.05 to 0.2, more preferably 0.07 to 0.15. Further, when a bleaching activator which is selected from alkanoyloxybenzene carboxylic acid which contains an alkanoyl group having 8 to 14 carbon atoms and salts thereof is used, the mass ratio of component (b2)/component (b1) is preferably 0.12 to 0.5, more preferably 0.15 to 0.4.

The content of component (c) in the liquid bleaching agent composition of the present invention is preferably 0.1 to 10 mass %, more preferably 0.2 to 5 mass %, and even more preferably 0.2 to 2 mass %, in terms of obtaining an excellent bleaching effect.

### Component (d)

The liquid bleaching agent composition of the present invention contains, as component (d), at least one compound selected from boric acid, borax and a borate. The borate includes sodium borate, potassium borate, ammonium borate, sodium tetraborate, potassium tetraborate and ammonium tetraborate.

### Component (e)

The liquid bleaching agent composition of the present invention contains, as component (e), a compound having one or more groups in which a hydroxyl group is present on each of the adjacent carbon atoms to each other.

Specific examples of component (e) are preferably the compounds described in the following (i) to (iv). At least one or more compounds selected from the group containing these compounds can be used.

(i) glycerin, diglycerin, triglycerin, alkyl (having 1 to 10 carbon atoms)polyglyceryl ether (for example, alkyl (having 1 to 10 carbon atoms) diglyceryl ether, alkyl (having 1 to 10 carbon atoms) triglyceryl ether)

(ii) sugar alcohols that are selected from sorbitol, mannitol, maltitose, inositol, and phytic acid

(iii) reducing sugars that are selected from glucose, apinose, arabinose, galactose, lyxose, mannose, gallose, aldose, idose, talose, xylose and fructose, and derivatives thereof (alkyl(poly)glycoside and the like)

(iv) polysaccharides selected from starch, dextran, xanthan gum, guar gum, curdlan, pullulan, amylose and cellulose.

According to the present invention, the (ii) sugar alcohols are preferred. They can be used alone or in combination of two or more. In terms of stability and a bleaching/washing effect, sorbitol is preferred.

The content of component (d) of the present invention is preferably in an amount of from 0.05 to 1.0 mass %, more preferably from 0.15 to 0.5 mass %, and even more preferably from 0.2 to 0.4 mass % as a boron atom. In addition, component (e) of the composition of the present invention is preferably contained in an amount of from 3 to 35 mass %, more preferably from 5 to 30 mass %, and even more preferably from 10 to 20 mass %.

[pH]

The pH value of the liquid bleaching agent composition of the present invention at 20° C. is 2.5 to 4.5, preferably 3.0 to 4.5, even more preferably 3.5 to 4.5. By having the storage pH within the range of 2.5 to 4.5, the composition of the present invention can have storage stability of hydrogen peroxide as component (a) and a bleaching activator as component (c). Such an undiluted liquid may have a pH value of less than 8.5 after it is diluted with water. According to the composition of the present invention, however, as containing a nonionic surfactant as component (b1) and an anionic surfactant as component (b2) in a specific mass ratio and a specific amount, even in the pH region wherein pH value is less than 8.5 after it is diluted with water, for example in the pH range of 7 to 8.5, the production of an organic peracid from a bleaching activator can be promoted after the composition is diluted with water. As a result, an excellent bleaching effect can be obtained. In general, the liquid bleaching agent composition of the present invention has pH of 7 to 8.5 at 20° C. when it is diluted with 1,000×dilution ratio (volume ratio).

### Other Components

The liquid bleaching agent composition of the present invention may contain a metal ion sequestering agent having phosphonic acid or bases thereof as component (f) in terms of improving stability of hydrogen peroxide. The content of component (f) preferably is in an amount of from 0.01 to 5 mass %, more preferably from 0.05 to 1 mass % in the composition.

(f) Specific examples of component (f) include organic phosphonic acid derivatives such as ethane-1,1-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, nitrilotrimethylenephosphonic acid and ethylenediaminetetrakismethylenephosphonic acid. These can be used alone or in combination of two or more. Among these, ethane-1-hydroxy-1,1-diphosphonic acid, ethylenediaminetetrakismethylenephosphonic acid and the like are preferred.

The liquid bleaching agent composition of the present invention may contain a solvent as component (g), in terms of preventing viscosity increase at low temperatures. Examples of component (g) include alcohols such as ethanol, propanol and butanol, glycols such as ethylene glycol, propylene glycol, trimethylene glycol, butyl diglycol, diethylene glycol and triethylene glycol, and polyalklyene glycol monoalkyl or aryl ethers such as diethyleneglycol butyl ether and triethyleneglycol phenyl ether. Among these, ethanol and propylene glycol are preferred.

To capture a hardness component, which is one of the factors that can inhibit the production of an organic peracid, the liquid bleaching agent composition of the present invention preferably contains a polymer compound as component (h), wherein a monoethylenic unsaturated monomer containing at least one selected from acrylic acid, methacrylic acid and salts thereof is polymerized to a polyether compound. Component (h) can be a polymer compound in which a monoethylenic unsaturated monomer containing acrylic acid and/or methacrylic acid as a main component is attached to the backbone of a polyether compound via graft polymerization.

Preferred examples of a polyether compound are the compounds that are represented by the following formula (h1).

Y—O(CH₂C₂O)ₙH (h1)

(wherein, Y represents a hydrogen atom, a methyl group, a phenyl group or a benzyl group, and n is a number between 2 to 200 representing the average added mole number of an oxyethylene group).

With respect to formula (h1), Y is preferably a methyl group or a phenyl group. n is preferably a number between 2 to 50.

The monoethylenic unsaturated monomer that is grafted to a polyether compound includes at least one selected from acrylic acid, methacrylic acid, and salts thereof. Salts of acrylic acid or methacrylic acid include alkaline metal salts, alkaline earth metal salts and ammonium salts. Alkaline metal salts, in particular sodium salts, are preferred. Preferred examples of a monoethylenic unsaturated monomer other than acrylic acid, methacrylic acid, and salts thereof include an unsaturated carboxylic acid or salts thereof. For example, maleic acid, fumaric acid, itaconic acid and salts thereof, and anhydrous maleic acid and the like can be mentioned. The ratio of at least one compound that is selected from acrylic acid, methacrylic acid, and salts thereof in a monoethylenic unsaturated monomer is preferably 10-100 mass %, and more preferably 20-70 mass %.

Preferably, the polymer compound as component (h) is obtained by polymerization so as to have the mass ratio between the polyether compound and the monoethylenic unsaturated monomer (polyether compound/monoethylenic unsaturated monomer) to be 0.25 or more. More preferably, the mass ratio of polyether compound/monoethylenic unsaturated monomer is 0.25 to 1, and even more preferably 0.3 to 0.7.

With respect to a specific method for producing component (h), those disclosed in JP-A 10-60476 can be mentioned. Salt type polymer compound can be easily obtained by cooling the acid type polymer compound followed by neutralization with an alkaline agent such as sodium hydroxide and the like. Alternatively, it is also possible that the acid type itself is added to a composition and then it can be neutralized in the composition to produce the salt type polymer compound.

Weight average molecular weight of the polymer compound as component (h) in the present invention is preferably 2,500-100,000, and more preferably 3,000-50,000 in terms of the stability of a bleaching activator.

In addition, according to the present invention, weight average molecular weight of the polymer compound is determined by the GPC (gel permeation chromatography) while using polyoxyethylene glycol as a standard material.

The content of component (h) is preferably in an amount of from 0.01 to 5 mass %, more preferably from 0.1 to 2 mass % in the composition, in terms of obtaining an effect of capturing a hardness component and pH jump effect.

In the liquid bleaching agent composition of the present invention, a surfactant other than a nonionic surfactant and an anionic surfactant as component (b) may be contained. The surfactant includes cationic surfactants and amphoteric surfactants that are described in the literature (Patent office Gazette, Publicly known and conventional technologies (Powder detergent for clinical use), Japanese Patent Office, Mar. 26, 1998, pages 4-22). The composition of the present invention preferably contains cationic surfactants and amphoteric surfactants in an amount of 0.01-3 mass %, more preferably 0.01-1 mass %. Meanwhile, since the cationic surfactants and the amphoteric surfactants tend to lower the stability of a bleaching activator, it is preferable that they are not blended in the composition.

In addition to the above, to the liquid bleaching agent composition of the present invention, an optional component such as a radical trapping agent, silicones, fungicides, a fluorescent dye, an enzyme and perfume can be further blended in. The liquid bleaching agent composition of the present invention contains water and the balance of the composition is usually water.

The water that can be used for the present invention includes ion exchange water from which metal dissolved in a very small amount in water is removed, distilled water and sterilized water containing a small amount of sodium hypochlorite. In terms of storage stability, ion exchange water or distilled water is preferable.

The liquid bleaching agent composition of the present invention is preferably prepared according to the method including the Step (A) to Step (C) described below, to obtain efficient blending considering that the surfactant concentration is high and the amount of blending water is small, and also to have an excellent washing/bleaching effect.

The production method preferred in the present invention includes the following steps; component (d), component (e) and water are admixed with one another, and an aqueous solution containing a boron compound in which the concentration of component (d) is 5-30 mass % in a premix and the content of water is 10-40 mass % is prepared (Step A), water and/or component (b1) and/or component (b2) is mixed with component (c) (Step B), and the aqueous solution of a boron compound obtained from Step A, the bleaching activator solution obtained from Step B, and component (a) are admixed with one another, if necessary, with other components that are also used for blending (Step C).

Regarding the method for obtaining an aqueous solution containing a boron compound of the present invention by dissolving component (d) in a mixture containing component (e) and water in Step A, an aqueous solution containing component (e) in an amount of 20-80 mass %, preferably 30-70 mass % (when the raw materials are supplied as an aqueous solution and the concentration of component (e) included therein satisfies the range, they can be used as they are) is prepared and then component (d) can be added thereto. By having component (e) the same or greater than the lower limit, the solubility of component (d) can be significantly increased. In addition, by having it the same or less than the upper limit, storage stability of the boron compound (i.e., solution stability) can be improved.

The content of component (d) is blended so as to obtain the content of 5-30 mass %, preferably 10-25 mass %, and more preferably 15-25 mass % in the aqueous solution containing a boron compound of the present invention. By having the content the same or greater than the lower limit, the size of a dissolution bath can be minimized so that equipment cost can be reduced. Further, by having it the same or less than the upper limit, solution stability of component (d) in the aqueous solution containing a boron compound of the present invention can be guaranteed. Still further, the content of component (d) in the aqueous solution containing a boron compound of the present invention is based on anhydrous compounds (i.e., anhydrous salt or a compound containing no water).

The content of component (e) is 10-70 mass %, preferably 20-65 mass %, and more preferably 30-60 mass % in the aqueous solution containing a boron compound of the present invention.

The content of water is 10-40 mass %, preferably 15-35 mass %, and more preferably 15-30 mass % in the aqueous solution containing a boron compound of the present invention.

Further, in terms of the solution stability of the aqueous solution containing a boron compound, the mass ratio between component (e) and water in the aqueous solution containing a boron compound, component (e)/water, is preferably 8/1-1/1, and more preferably 5/1-1/1.

The mass ratio between component (d) and component (e) in the aqueous solution containing a boron compound, is preferably 1/5-5/1, and more preferably 1/3-3/1. Within such range, the solubility and the solution stability are improved. In particular, in terms of the solution stability that can be maintained well at low temperatures, the storage temperature for the aqueous solution containing a boron compound can be lowered so that the production cost can be saved.

pH of the aqueous solution containing a boron compound of the present invention is 1 to 9, preferably 2 to 8, and more preferably 2 to 6 at 25° C. Below the lower limit, problems such as corrosion of an equipment, etc. may occur. Further, above the upper limit, the solution stability of the aqueous solution containing a boron compound is reduced. Thus, to adjust the pH in the specific range, pH can be controlled only by component (d) or an additional pH adjusting agent can be used. Examples of the pH adjusting agent include sodium hydroxide, potassium hydroxide, sodium carbonate and amines. Sodium hydroxide is preferred. When the pH adjusting agent is added all at once, the color of the composition can be impaired. Thus, it is necessary to control the addition speed with stirring, etc.

For the process of adjusting an aqueous solution containing a boron compound of the present invention, a stirrer or a mixer which is generally used for the production of a liquid bleaching agent composition or a liquid detergent composition can be used for stirring and mixing each of the components, depending on blending scale thereof. Not being specifically limited, the blending temperature is 10 to 80° C., preferably 20 to 70° C., and more preferably 30 to 60° C. to promote the dissolution of boric acid.

The bleaching activator as component (d2) in Step B of the present invention may be any one of a raw powder or a solution state prepared by dissolving the component in any solvent. In terms of efficiency, it is preferable to use it in a solution state, in particular an aqueous solution, same as the aqueous solution containing a boron compound. A preferred example of the solution state includes a process described in JP-B-2938788, paragraph [0029]. Specifically, a solution prepared by dissolving in advance a bleaching activator in water, a nonionic surfactant (b1) and/or an anionic surfactant (b2) and adjusting the pH to from 3 to 7, preferably from 4 to 6, is preferable. Not being specifically limited, the blending temperature is 10 to 80° C., preferably 20 to 70° C., and more preferably 30 to 60° C. to promote the dissolution of a bleaching activator.

In Step C of the present invention, considering the stability of component (d) and component (e) in a liquid bleaching detergent composition, it is preferable that part of component (e) and part of water, compared to the total amount blended in a final product, are blended with the an aqueous solution containing a boron compound, followed by blending additionally the remainder of each to produce a liquid bleaching detergent composition. Further, in terms of the storage stability of a bleaching activator solution, it is preferable that part of component (b1) and/or component (b2), compared to the total amount blended in a final product, is blended with the bleaching activator solution (premix of a bleaching activator), followed by blending additionally each of the remainder to produce a liquid bleaching detergent composition. More preferably, with respect to the components (d), (e), (b1) and (b2), both of the methods can be performed. More preferred and specific example includes that, with respect to the production method including Step A to Step C, the aqueous solution containing a boron compound as obtained from Step A, component (e) in an amount that has not been blended in the aqueous solution containing a boron compound, water and other components are admixed with one another, component (b1) and/or component (b2) in an amount that has not been blended in the bleaching activator solution are mixed and dissolved therein, pH at 20° C. is adjusted to 2.5 to 7, and then the bleaching activator solution is added and mixed thereto.

Further, when a liquid bleaching detergent composition containing a solvent as component (g) is to be produced, it is preferable to mix an aqueous solution containing a boron compound with component (g), before mixing the aqueous boron solution with component (a), component (c), component (b1) and component (b2), in terms of shortening a time required for operational process.

Further, when an optional component is also blended in, unstable bases such as an enzyme and perfume are preferably added at the last step of the operational process. Also, bases that are used in conjunction with a surfactant for enhancing an emulsifying and solubilizing effect are preferably premixed with the surfactants and then added. That is, depending on characteristics of a component to be blended, mixture time and mixture form are preferably varied.

Still further, the liquid detergent composition that is obtained according to the method of the present invention can be re-adjusted with a pH adjusting agent. However, much care is needed not to impair the stability of the bleaching activator.

### EXAMPLES

The following Examples are described as implementations of the present invention. The Examples are illustrative of the present invention and are not intended to limit the present invention.

The liquid bleaching agent compositions (Products of the present invention 1 to 8 and Comparative Products 1 to 8) were obtained by mixing the components shown in Table 1 and, if necessary, by adjusting to a predetermined pH of an undiluted liquid using 48% NaOH aqueous solution or 20% H₂SO₄ aqueous solution. Thus obtained liquid bleaching agent compositions were evaluated regarding storage stability (residual degree of a bleaching activator), amount of an organic peracid produced just after blending, and bleaching power (bleaching degree after storage). The results are summarized in Table 1. In addition, pH of the liquid bleaching agent composition after being diluted 1000 times by volume with water at 20° C. is also shown in Table 1.

For each components described in the table, the followings were used. EO is an abbreviation of ethyleneoxide.

### <Blending Component>

a-1: Hydrogen peroxide
b1-1; Polyoxyethylenelauryl ether (EO average added mole number 8)
b1-2; C₁₂11₂₅O—(C₂H₄O)₆—(C₃H₆O)₂—(C₂H₄O)₅—H
b1-3; Polyoxyethylenelauryl ether (EO average added mole number 12)
b-1-4; a nonionic surfactant wherein average 7 moles of EO are added to a secondary linear alcohols having 10 to 14 carbon atoms
b1-5; APG (polyalkylglucoside, carbon atom number of 12 in alkyl group, average sugar condensation degree of 1.5)
b2-1; Sodium laurylbenzenesulfonate
b2-2; Sodium polyoxyethylenelauryl ether sulfonate (EMAL 20C, manufactured by Kao Corporation)
b3-1: N-Dodecyl-N,N,N-trimethylammoniummethyl sulfuric acid ester salt
c-1; sodium decanoyloxy-p-benzenesulfonate
c-2: Isononanoyloxy-p-benzene carboxylic acid (3,5,5-trimethylhexanoyloxy-p-benzene carboxylic acid)
c-3: Sodium nonanoyloxy-p-benzene sulfonate
c-4: Decanoyloxy-p-benzene carboxylic acid
d-1; Boric acid (when the blending amount in the table is, for example, 1.5 mass %, it corresponds to 0.26 mass % as a boron atom)
d-2: Tetrasodium borate (when the blending amount in the table is, for example, 1 mass %, it corresponds to 0.21 mass % as a boron atom)
e-1; Sorbitol
e-2; Glucose
e-3; Mannitol
f-1: 1-Hydroxyethyliden-1,1-diphosphonic acid (Dequest 2010, manufactured by Solutia)
g-1; 4-Methoxyphenol
g-2: 4-Hydroxybenzene sulfonic acid
h-1; Polymer compound that is obtained according to the Synthetic example 1 described below.

### Synthetic Example 1

To a glass reactor equipped with a thermometer, a stirrer, a tube for introducing nitrogen gas, and a reflux condenser, 100 parts by weight of phenoxypolyethylene glycol having average molecular weight of 1,500 and 5 parts by weight of maleic acid were added. Under the nitrogen stream, the mixture was solubilized with heating and the temperature was raised to 150° C. with stirring. Then, while maintaining the temperature at 150-151° C., 30 parts by weight of acrylic acid, and 4.5 parts by weight of di-t-butylperoxide were added separately in continuous manner for one hour. Stirring was further carried out for 40 minutes. After cooling, 135 parts by weight of pure water was added to obtain the polymer compound (h-1). The weight average molecular weight of the polymer was about 15,000 (converted to polyethylene glycol).

### <Storage Stability>

The content of the bleaching activator in the liquid bleaching agent composition was measured before storage (just after the production) and after 1 week at 40° C. by a high performance liquid chromatography and the residual degree of the bleaching activator was determined by the following equation:

Residual degree of the bleaching activator (%)=(content of the bleaching activator after storage)/(content of the bleaching activator before storage)×100

### <Measurement Method of an Organic Peracid>

To a 3 L beaker, 3 L of ion exchange water (30° C.) was added and 3 ml of the liquid bleaching agent composition (just after the production) shown in Table 1 was added thereto. After stirring for 15 minutes, 0.5 ml of 1% aqueous catalase solution was added followed by further stirring for 3 minutes. To the resulting solution, 10 ml of potassium iodide solution (10 mass %) and 20 ml of sulfuric acid solution (20 mass %) were added. Then, by titrating the solution with sodium thiosulfate solution (0.02 mol/l), the amount of the organic peracid produced was calculated based on the following equation:

Produced amount of organic peracid (μmol)=0.02×(titration amount of sodium thiosulfate (ml)/10³×0.5×10⁶

### <Evaluation Method of Washing Power>

The liquid bleaching agent composition shown in Table 1 was stored at 40° C. for 1 week and then added to a concentration of 0.1 vol % with 3° DH hard water, and by using the resulting dilution, 4 pieces of clothes stained with meat sauce prepared below were washed in a Turgo-to-meter (100 rpm×10 minutes). Thereafter, the meat sauce stained clothes were rinsed with tap water and then dried to determine the degree of bleaching by the following equation:

Degree of bleaching (%)=(reflectance of the stained clothes after bleaching−reflectance of the stained clothes before bleaching)/(reflectance of white cloth−reflectance of the stained clothes before bleaching)×100

The reflectance was measured with NDR-10DP with a 460-nm filter, manufactured by Nippon Denshoku Kogyo Co., Ltd. The white cloth indicates a non-stained cloth that is the same as the one used for preparing a stained cloth (Cotton gold cloth #2003).

### (Preparation of the Stained Clothes)

From the meat sauce manufactured by Kagome, Co., Ltd. (meat sauce prepared from ripen tomatoes; expiration date, Aug. 9, 2008, Lot No: D6809JC)/a canned product containing the net weight of 295 g), solid matters were removed by mesh filtration (mesh size; 500 μm). The resulting liquid was heated until boiling. Then, cotton Calico #2003 were dipped in the resulting meat sauce and boiled for 15 minutes. After stopping the heating, the mixture containing the cloth was allowed to sit for about two hours. Once the temperature reached 30° C. the cloth was removed and the residual liquid was scraped off using a spatula. The cloth was air-dried, pressed to give a test cloth having a size of 8 cm×8 cm, and then used for the experiment.

TABLE 1

| | | | | Product of the invention | | | | | | | |
|---|---|---|---|---|---|---|---|---|---|---|---|
| | | | | 1 | 2 | 3 | 4 | 5 | 6 | 7 | 8 |
| Liquid | Compounded | (a) | a-1 | 5 | 3 | 2 | 3 | 5 | 4 | 2 | 3 |
| detergent | component | (b1) | b1-1 | | 12 | | | | | | 20 |
| composition | (% by mass) | | b1-2 | 18 | 6 | | 30 | | 19 | | |
| | | | b1-3 | 22.5 | 8 | 25 | 15 | 20 | 19 | 16 | |
| | | | b1-4 | | 16 | 15 | 10 | 12 | | 16 | 20 |
| | | | b1-5 | | | | | | | | |
| | | (b2) | b2-1 | | 5 | 3 | | 2 | | 7 | |
| | | | b2-2 | 5 | | | 8 | | 5 | | 15 |
| | | | b3-1 | | | | | | | | |
| | | (c) | c-1 | 1 | | 1.6 | 2 | | | | |
| | | | c-2 | | | | | | 1 | | |
| | | | c-3 | | 1.2 | | | 1.5 | | | |
| | | | c-4 | | | | | | | 1 | 1.5 |
| | | (d) | d-1 | | 1.8 | 1.5 | 1 | 2 | 2 | 1.5 | 2 |
| | | | d-2 | 1.2 | | | | | | | |
| | | (e) | e-1 | 10 | | 10 | 12 | 15 | 15 | 12 | |
| | | | e-2 | | | | | | | | |
| | | | e-3 | | 14 | | | | | | 15 |
| | | (f) | f-1 | 0.2 | 0.2 | 0.2 | 0.1 | 0.1 | 0.1 | 0.2 | 0.1 |
| | | (g) | g-1 | | 0.2 | | | | | | |
| | | | g-2 | 0.2 | | | | | | | |
| | | (h) | h-1 | | | | | | 2 | 0.5 | |
| | | Ion exchange water | | Balance | Balance | Balance | Balance | Balance | Balance | Balance | Balance |
| | | Total | | 100 | 100 | 100 | 100 | 100 | 100 | 100 | 100 |
| | (b2)/(b1) (mass ratio) | | | 0.12 | 0.12 | 0.075 | 0.15 | 0.063 | 0.13 | 0.22 | 0.38 |
| | pH | | undiluted liquid | 4.0 | 3.5 | 3.8 | 3.5 | 3.0 | 4.3 | 4.5 | 4.2 |
| | (20° C.) | | solution diluted 1000 | 8.1 | 7.8 | 8.0 | 7.8 | 7.5 | 8.1 | 8.3 | 8.2 |
| | | | times by mass | | | | | | | | |
| Remaining rate of bleaching | | | | 74 | 99 | 97 | 78 | 100 | 93 | 90 | 80 |
| activator (%) | | | | | | | | | | | |
| Production amount of organic peracid | | | | 37 | 45 | 30 | 42 | 20 | 29 | 52 | 79 |
| (μmol) | | | | | | | | | | | |
| Bleaching rate (%) [after storage] | | | | 88 | 92 | 90 | 88 | 80 | 86 | 94 | 96 |
| | | | | Comparative product | | | | | | | |
| | | | | 1 | 2 | 3 | 4 | 5 | 6 | 7 | 8 |
| Liquid | Compounded | (a) | a-1 | 4 | 5 | 3 | 2 | 3 | 2 | 5 | 2 |
| detergent | component | (b1) | b1-1 | | | 12 | | | | | |
| composition | (% by mass) | | b1-2 | 20 | 12 | 6 | | 30 | | 12 | |
| | | | b1-3 | | 15 | 8 | 25 | 15 | 25 | 15 | 14 |
| | | | b1-4 | | | 16 | 15 | 10 | 15 | | 8 |
| | | | b1-5 | | | | | | | | |
| | | (b2) | b2-1 | 1 | | | | | 1 | | 3 |
| | | | b2-2 | | 1 | 1 | | 8 | | 15 | |
| | | | b3-1 | 0.1 | | | | | | | |
| | | (c) | c-1 | | 1 | | 1.6 | 2 | 1.6 | 1 | 1.6 |
| | | | c-2 | 1 | | | | | | | |
| | | | c-3 | | | 1.2 | | | | | |
| | | | c-4 | | | | | | | | |
| | | (d) | d-1 | 1 | | 1.8 | 1.5 | 1 | 1.5 | | 1.5 |
| | | | d-2 | | 1.2 | | | | | 1.2 | |
| | | (e) | e-1 | | 10 | | 10 | 12 | 10 | 10 | 10 |
| | | | e-2 | 8 | | | | | | | |
| | | | e-3 | | | 14 | | | | | |
| | | (f) | f-1 | 0.2 | 0.2 | 0.2 | 0.2 | 0.1 | 0.2 | 0.2 | 0.2 |
| | | (g) | g-1 | | | 0.2 | | | | | |
| | | | g-2 | | 0.2 | | | | | 0.2 | |
| | | (h) | h-1 | | | | | | | | |

| | | | | | | | | |
|---|---|---|---|---|---|---|---|---|
| Ion exchange water | Balance | Balance | Balance | Balance | Balance | Balance | Balance | Balance |
| Total | 100 | 100 | 100 | 100 | 100 | 100 | 100 | 100 |

| (b2)/(b1) (mass ratio) | | 0.050 | 0.037 | 0.024 | 0.000 | 0.15 | 0.025 | 0.56 | 0.14 |
|---|---|---|---|---|---|---|---|---|---|
| pH | undiluted liquid | 3.5 | 4.0 | 3.5 | 3.8 | 4.7 | 3.8 | 4.0 | 3.8 |
| (20° C.) | solution diluted 1000 | 7.7 | 8.1 | 7.9 | 8.0 | 8.5 | 8.0 | 8.0 | 8.1 |
| | times by mass | | | | | | | | |

| | | | | | | | | |
|---|---|---|---|---|---|---|---|---|
| Remaining rate of bleaching | 96 | 54 | 98 | 100 | 15 | 99 | 0 | 37 |
| activator (%) | | | | | | | | |
| Production amount of organic peracid | 0 | 11 | 4 | 0 | 67 | 3 | 75 | 45 |
| (μmol) | | | | | | | | |
| Bleaching rate (%) [after storage] | 45 | 67 | 58 | 52 | 69 | 54 | 48 | 67 |

### <Production Method>

The production method of the present invention is now explained in view of the following Examples. The use of the used composition is not specifically limited. However, as one example of such use, a bleaching agent composition is exemplified below.

A composition which contains as a blending component (a-1) 3%, (b1-2) 30%, (b1-3) 15%, (b2-1) 5%, (c-1) 1.5%, (d-1) 1.5%, (e-1) 12%, (f-1) 0.1%, (g-2) 0.2%, (h-1) 0.3%, (perfume) 0.3%, and water as remainder was prepared according to the three production methods described below (pH 3.9). With respect to thus obtained liquid bleaching detergent compositions, dissolution state and preservation stability were determined. The results are described below. The storage stability was determined in the same manner as described in the above.

The blending for Step C (principal blending process) was performed with 4 kg scale (using 5 L beaker, whole addition amount: 4 kg). For stirring, a stirrer in which a wing (diameter 10 cm) having three paddles is attached to Three One Motor (trade name: HEIDON 1200G, manufactured by Shinto Scientific Co., Ltd.) was used. Further, during the addition of blending components, revolution number of the paddle was maintained at 250 rpm.

### Example 1 of Working Method 1

For Step A, component (d-1), component (e-1) and water were admixed with one another in mass ratio of 15:60:25. The mixture was dissolved under stirring and heating at 40° C. to give a transparent and homogeneous aqueous solution containing a boron compound.

For Step B, component (c-1) and water were admixed with each other in mass ratio of 25:75. The mixture was dissolved under stirring and heating at 50° C. to give a transparent and homogeneous aqueous solution containing a bleaching activator.

For Step C (principal blending process), the aqueous solution containing a boron compound that has been prepared in Step A, component (e-1) in an amount that has not been blended in the aqueous solution containing a boron compound, water in an amount that has not been blended in the aqueous solution containing a boron compound, component (f-1), component (g-2) and component (h-1) were admixed with another under stirring, followed by addition of component (b1-2), component (b1-3) and component (b2-1) thereto to give a homogeneous solution. Then, NaOH with an amount that is required for adjusting pH of the liquid bleaching detergent composition to be 3.9 was added, and the bleaching activator solution prepared from Step B and the perfume were added thereto. Finally, component (a-1) was added and the mixture was stirred at 30° C. for 10 minutes to obtain a liquid bleaching detergent composition with a transparent and homogeneous appearance. The residual degree of component (c-1) after the storage of the composition was 98%.

### Example 2 of Working Method

Step A and Step B were carried out similar to Example 1 of working method. As a result, an aqueous solution containing a boron compound and a bleaching activator solution were prepared, respectively.

Next, as Step C′ (principal blending process), the aqueous solution containing a boron compound, the bleaching activator solution, and all other components required to provide the composition 3 of the present invention (component (e-1) or water and the like that has not been blended in an aqueous solution containing a boron compound and a bleaching activator solution but required to complete the composition 3 of the present invention may be contained), including NaOH for adjusting pH to that of the composition 3 were admixed with one another while being simultaneously stirred. After further stirring for 20 minutes at 30° C., a liquid bleaching detergent composition with a transparent and homogeneous appearance was obtained. The residual degree of component (c-1) after the storage of the composition was 92%.

### Example 3 of Working Method

For Step C″ (principal blending process), without using the aqueous solution containing a boron compound of Step A and the bleaching activator solution of Step B, all the components were added as it was at the same time and stirred for 20 minutes at 30° C. State of the mixture was examined with naked eyes, and some undissolved matters were found. Thus, stirring was again carried out for three hours at 30° C. to obtain a liquid bleaching detergent composition with a transparent and homogeneous appearance. The residual degree of component (c-1) after the storage of the composition was 85%.

1. A liquid bleaching agent composition comprising component (a), component (b1), component (b2), component (c), component (d) and component (e), wherein the content of component (b1) is 25-60 mass %, the content of component (b2) is 1.5-20 mass %, the mass ratio of component (b2) to component (b1) is 0.05-0.5 and the composition has pH 2.5-4.5 at 20° C.;
component (a): hydrogen peroxide
component (b1)): a nonionic surfactant
component (b2): an anionic surfactant
component (c): a bleaching activator
component (d): at least one compound selected from the group consisting of boric acid, borax and a borate, and,
component (e): a compound having one or more groups in which a hydroxyl group is present on each of the adjacent carbon atoms to each other.

2. The liquid bleaching agent composition according to claim 1, further comprising a polymer compound in which a monoethylenic unsaturated monomer comprising acrylic acid and/or methacrylic acid as a main component is attached to the backbone of a polyether compound via graft polymerization.

3. The liquid bleaching agent composition according to claim 1 or 2, wherein the liquid bleaching agent composition has a pH of 7 to less than 8.5 at 20° C. when the composition is diluted with 1,000 times as much water by volume as the compositon.

4. A process for producing the liquid bleaching composition according to claim 1, comprising mixing the components by a method including the following Step A, Step B, and Step C;
Step A (a concentrated premix of component (d)):
Preparing an aqueous solution of a boron compound in which the concentration of component (d) is 5-30 mass % and the concentration of water is 10-40 mass % in a premix by mixing component (d), component (e) and water;
Step B (concentrated premix of component (c)):
Mixing water and/or component (b1) and/or component (b2) with component (c);
Step C (principal blending process):
Mixing the aqueous solution of a boron compound obtained by Step A, the bleaching activator solution obtained by Step B, and component (a) and, if necessary, other components.

5. A process for producing the liquid bleaching composition according to claim 1, comprising mixing a solution obtained by Step A, before mixing at least one of component (a), component (b1), component (b2) and component (c);
Step A (a concentrated premix of component (d)):
Preparing an aqueous solution of a boron compound in which the concentration of component (d) is 5-30 mass % in a premix and the concentration of water is 10-40 mass % by mixing component (d), component (e) and water.

6. A process for producing the liquid bleaching composition according to claim 1, comprising, after initiating mixing of the solution obtained by Step A below with other detergent components, mixing component (b1) and/or component (b2), being adjusted to pH 2.5-7, and subsequently mixing component (a) and the solution obtained by Step B below with the mixture;
Step A (a concentrated premix of component (d)):
Preparing an aqueous solution of a boron compound in which the concentration of component (d) is 5-30 mass % in a premix and the concentration of water is 10-40 mass % by mixing component (d), component (e) and water;
Step B (concentrated premix of component (c)):
Mixing water and/or component (b1)) and/or component (b2) with component (c).
